(19) United States
(12) Patent Application Publication
(10) Pub. No.: US 2007/0172321 A1
(43) Pub. Date: Jul. 26, 2007

(54) Ball endmill

(76) Inventor: Tamotsu Nagai, Aichi (JP)

Correspondence Address: Muramatsu & Associates, 114 Pacifica, Suite 310, Irvine, CA, 92618, US

(21) Appl. No.: 11/578,750

(22) PCT Filed: Jan. 18, 2005
(86) PCT No.: PCT/JP05/00514

§ 371 Date: Oct. 16, 2006

(30) Foreign Application Priority Data
Apr. 20, 2004 (JP) 2004-124725

(51) Int. Cl. B26D 1/12

(52) U.S. Cl. 407/53

(57) ABSTRACT

A ball endmill includes a cylindrical tool body that is to be rotated about its axis, ball-nosed end cutting edges located in an axially distal end portion of the tool body and describing a semi-spherical-shaped locus during rotation of the tool body, and spiral gashes located in the axially distal end portion of the tool body and defining rake faces of the respective ball-nosed end cutting edges. The tool body is made, at least at its part providing each ball-nosed end cutting edge, of a hard sintered body. Each ball-nosed end cutting edge is inclined with respect to the axis by a helix angle in a range from about 10° to about 30°. The tool body has, in its distal end, a non-gashed central area in which the spiral gashes do not exist. A ratio of a size of the non-gashed central area to a ball nose radius is in a range from about 0.03 to about 0.1.

### TECHNICAL FIELD

The present invention relates to a ball endmill, and more particularly to such a ball endmill that is capable of exhibiting a machining 14

### BACKGROUND ART

In an operation performed by a machine tool such as machining center for profile-machining of a die or mold, it is common that a ball endmill made of cemented carbide is used. Where the ball endmill is used to machine a workpiece that is made of a material hardened for a longer service life, cutting blades of the endmill are easily worn whereby its tool life is shortened. The tool life could be increased, for example, by reducing a depth of cut in the machining operation. However, the reduction in the depth of cut inevitably increases a length of time required for the machining operation, thereby resulting in reduction in the machining efficiency. In recent years, for reducing the wear on the cutting blades without reducing the machining efficiency, there is used a ball endmill whose cutting blades are constituted by polycrystalline cubic boron nitride (PCBN).

JP-2001-300813A discloses a ball endmill having cutting blades that are constituted by polycrystalline hard sintered body containing cubic boron nitride. In this ball endmill with the cutting blades having a high degree of hardness owing to the polycrystalline hard sintered material, plate members are brazed to corner portions of the tool body made of cemented carbide. Each of the plate members, which is formed with a cutting edge, is provided by a two-layered body in which a layer made of polycrystalline hard sintered material and a layer made of cemented carbide is integrally fixed to each other.

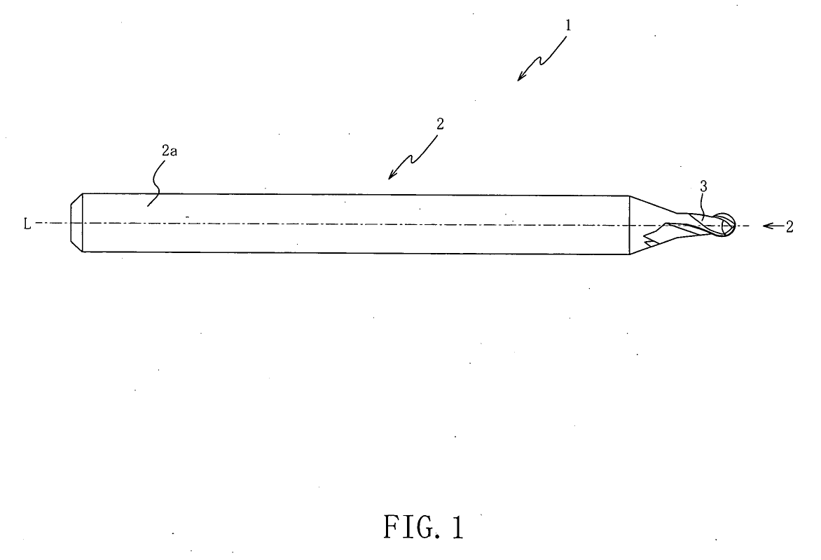

Patent Document 1: JP-2001-300813A (see FIG. 1 etc.)

### DISCLOSURE OF INVENTION

### Object to be Solved by the Invention

However, the above-described ball endmill is not capable of machining a workpiece at a high speed or with a large depth of cut, since a cutting resistance acting on the ball endmill is large due to its construction in which each of the cutting edges extends straight as seen in an end view perpendicular to an axis of the tool body. That is, there is a problem that a sufficiently high machining efficiency can not be obtained by the construction in which the plate members each provided by the two-layered body are brazed to the corner portions of the tool body.

The present invention was developed for solving the above-described problem, and has an object to provide a ball endmill that is capable of performing a machining operation with an improved machining efficiency.

### Measures for Achieving the Object

For achieving the object, claim 1 defines a ball endmill including a tool body having an axis, ball-nosed end cutting edges provided in a distal end portion of the tool body and defining a generally semi-spherical shape, and spiral gashes providing rake faces of the respective ball-nosed end cutting edges, wherein the tool body is constituted, at least at a part thereof providing each of the ball-nosed end cutting edges, by a hard sintered body, wherein a helix angle of each of the spiral gashes is in a range from about 10° to about 30°, and wherein a non-gashed central area in which the spiral gashes do not exist has a size in a range from about 0.03R to about 0.1R relative to a ball nose radius R of said ball endmill.

According to claim 2, in the ball endmill defined in claim 1, a rake angle on each of the ball-nosed end cutting edges is in a range from about −30° to about −10°.

According to claim 3, in the ball endmill defined in claim 1 or 2, the hard sintered body is constituted principally by cubic boron nitride.

### Effects of the Invention

In the ball endmill defined in claim 1 in which the ball-nosed end cutting edges are provided in the distal end portion of the tool body, since the tool body is constituted, at least at the part providing each of the ball-nosed end cutting edges, by the hard sintered body, the ball endmill is capable of performing a machining operation at a higher speed with a larger depth of cut, as compared with a ball endmill whose ball-nosed end cutting edges are constituted by cemented carbide. Thus, the present ball endmill provides an advantage of improving a machining efficiency.

Further, the rake face of each of the ball-nosed end cutting edges, which are provided in the distal end portion of the tool body, is defined by the spiral gash, so that each of the ball-nosed end cutting edges is defined by a circular arc, as seen in a distal end view perpendicular to the axis of the tool body, which is convex in a direction of rotation of the tool body (i.e., in a direction of cutting action of the tool). Owing to this construction, a cutting resistance acting on the ball endmill can be made smaller than in a conventional ball endmill in which each ball-nosed end cutting edge is defined by a straight line as seen in the distal end view. The reduction in the cutting resistance permits the ball endmill to perform a machining operation at an increased speed with an increased depth of cut, thereby leading to an improvement in the machining efficiency.

Further, the helix angle of each of the spiral gashes is in the range from about 10° to about 30°. In general, an increase in the helix angle of each spiral gash leads to easy chipping of the cutting edge and the consequent reduction in the tool life. However, in the present invention, since the helix angle is not larger than about 30°, it is possible to prevent the chipping of the cutting edge and accordingly to prolong the tool life.

On the other hand, a reduction in the helix angle of each spiral gash leads to reduction in the cutting performance of each ball-nosed end cutting edge, making it impossible to obtain a sufficiently high machining efficiency. However, in the present invention, since the helix angle is not smaller than about 10°, it is possible to prevent the reduction in the cutting performance of each ball-nosed end cutting edge and accordingly to obtain a sufficiently high machining efficiency.

Further, the non-gashed central area in which the ball-nosed end cutting edges or spiral gashes are absent has a size in a range from about 0.03R to about 0.1R relative to the ball nose radius R of the ball endmill. In this non-gashed central area, i.e., an end-cutting-edge absence area, a rotational speed is slow, and a large friction is generated. Therefore, if a thickness of the non-gashed central area is excessively reduced, the tool body is likely to be easily broken at the non-gashed central area due to reduction in rigidity of the tool body at the non-gashed central area. However, in the present invention, since the non-gashed central area in which the spiral gashes do not exist is not smaller than about 0.03R relative to the ball nose radius R of the ball endmill, it is possible to prevent breakage of the tool body at the non-gashed central area and accordingly to prolong the tool life.

On the other hand, if the thickness of the non-gashed central area is excessively increased, the friction acting between the non-gashed central area and a machined surface of the workpiece is increased whereby a smoothness of the machined surface is reduced, so that a satisfactory surface finish can not be obtained. However, in the present invention, since the non-gashed central area is not larger than about 0.1R relative to the ball nose radius R of the ball endmill, it is possible to prevent reduction in the smoothness of the machined surface and accordingly to obtain a satisfactory surface finish.

In the ball endmill defined in claim 2, in addition to the features provided by the ball endmill defined in claim 1, there is a feature that the rake angle on each of the ball-nosed end cutting edges is in a range from about −30° to about −10°. In general, if the rake angle on each ball-nosed end cutting edge is a large positive value, the cutting edge could easily suffer from chipping, resulting in reduction in the tool life. However, in the present invention, since the rake angle on each ball-nosed end cutting edge is not larger than about −10°, it is possible to prevent chipping of the cutting edge and accordingly to prolong the tool life.

On the other hand, if the rake angle on each ball-nosed end cutting edge is a large negative value, the cutting performance of each ball-nosed end cutting edge is reduced whereby a sufficiently high machining efficiency cannot be obtained. However, in the present invention, since the rake angle on each ball-nosed end cutting edge is not smaller than −30°, it is possible to prevent the reduction in the cutting performance of each ball-nosed end cutting edge and accordingly to obtain a sufficiently high machining efficiency.

It is common that, in a ball endmill made of cemented carbide, the rake angle on each ball-nosed end cutting edge is in a range of positive value for improving a cutting performance, and that the cutting edge is chamfered for preventing chipping of the cutting edge. On the other hand, in the present invention, at least the part of the tool body providing each ball-nosed end cutting edge is constituted by the hard sintered body, and the rake angle on each ball-nosed end cutting edge is in a range of negative value for obtaining strength of the cutting edge. The arrangement of the present invention eliminates necessity of chamfering the cutting edge, thereby providing an advantage of simplifying a process of manufacturing the ball endmill.

In the ball endmill defined in claim 3, in addition to the features provided by the ball endmill defined in claim 1 or 2, there is a feature that the hard sintered body is constituted principally by the cubic boron nitride. In this arrangement, the part of the tool body providing each ball-nosed end cutting edge is constituted by the cubic boron nitride which is harder than the cemented carbide, there is an advantage of providing the cutting edge with a high degree of wear resistance and also preventing reduction in smoothness of the machined surface.

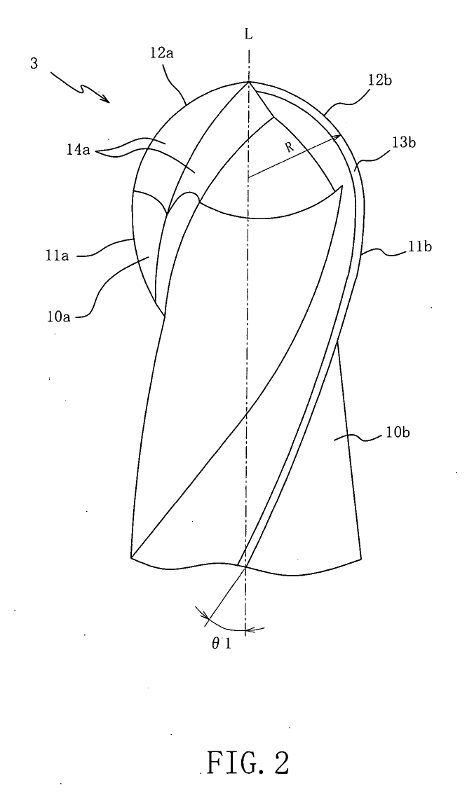

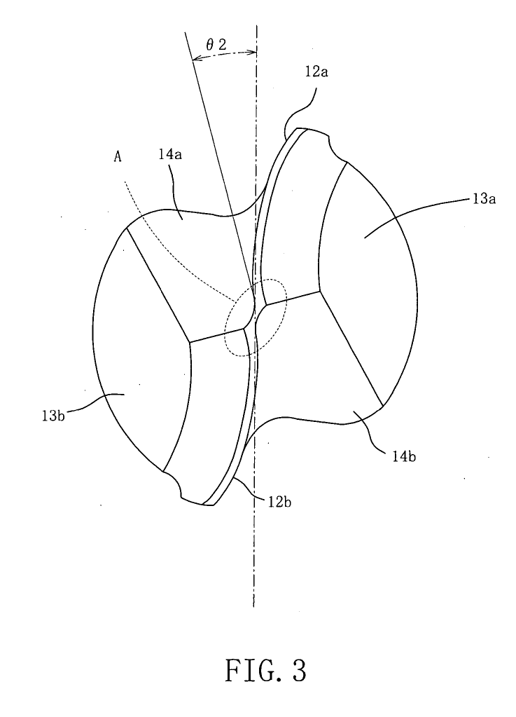

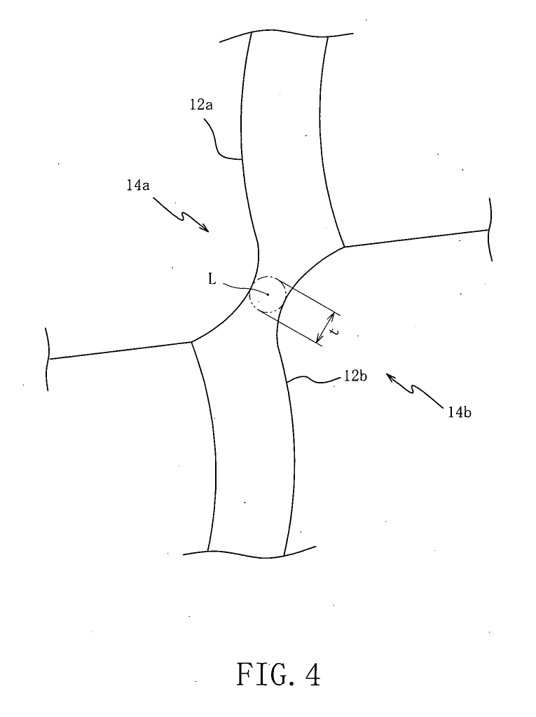

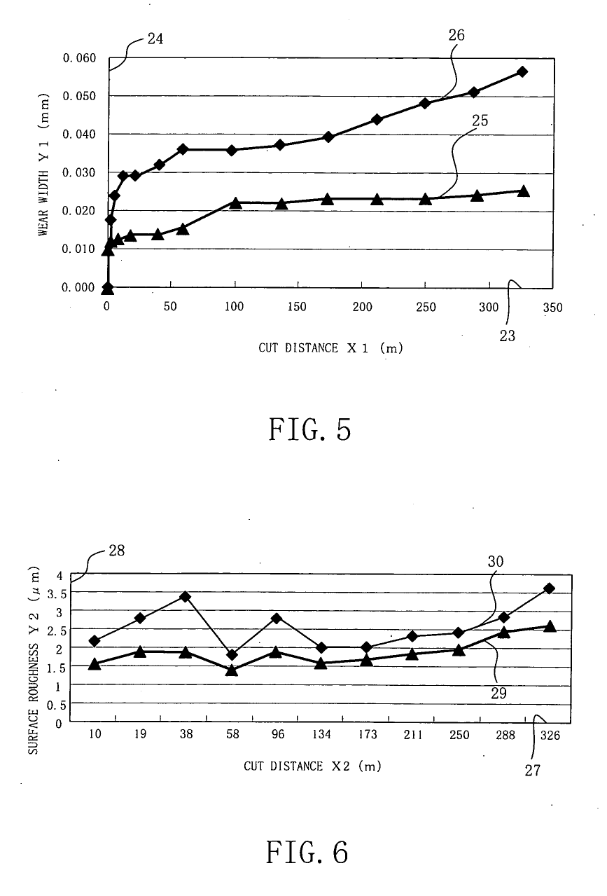

### BRIEF DESCRIPTION OF DRAWINGS

[FIG. 1] A front view of a ball endmill according to an embodiment of the present invention.

[FIG. 2] An enlarged view of a distal end portion of the ball endmill.

[FIG. 3] A side view of the ball endmill as seen in a direction of arrow II of FIG. 1.

[FIG. 4] An enlarged view showing in enlargement a portion defined by broken line A of FIG. 3.

[FIG. 5] A view showing a result of a cutting test conducted by using a product A according to the invention and a conventional product B.

[FIG. 6] A view showing a result of the cutting test conducted by using the product A according to the invention and the conventional product B.

### EXPLANATION OF REFERENCE SIGNS

1 ball endmill
2 tool body
3 blade portion
10a, 10b chip-evacuation flute
11a, 11b peripheral cutting edge
12a, 12b ball-nosed end cutting edge
14a, 14b spiral gash
θ1 helix angle of peripheral cutting edge
θ2 helix angle of spiral gash (helix angle of ball-nosed end cutting edge)
t thickness of non-gashed central area

### BEST MODE FOR CARRYING OUT THE INVENTION

Hereinafter, a preferred embodiment of the present invention will be described with reference to the drawings. FIG. 1 is a front elevational view of a multi-flute ball endmill 1 (hereinafter simply referred to as “ball endmill”) according to the embodiment of the invention. FIG. 2 is an enlarged view of a distal end portion (right-side portion as seen in FIG. 1) of the ball endmill 1. FIG. 3 is a side view of the ball endmill 1 as seen in a direction of arrow II of FIG. 1. Referring first to FIGS. 1-3, there will be described a whole construction of the ball endmill 1.

The ball endmill 1 is principally constituted by a tool body 2 having an axis L and including a blade portion 3 and a shank portion 2a that are coaxial with each other. This ball endmill 1 is to be used for cutting or machining a workpiece so as to finish a free curved surface or rounded corner section surface of a die or molding. In a machining operation, the ball endmill 1 is attached to a machine tool such as machining center through a holder (not shown) that is arranged to hold the shank portion 2a of the tool body 2, and is rotated about the axis L and moved by the machine tool. The tool body 2 is made of cemented carbide that is formed of pressure-sintered tungsten carbide (WC) or the like. In the present embodiment, the shank portion 2a has a diameter of about 6 mm.

The blade portion 3, by which the machining operation is carried out on the workpiece, has chip-evacuation flutes 10a, 10b, peripheral cutting edges 11a, 11b, ball-nosed end cutting edges 12a, 12b, lands 13a, 13b and spiral gashes 14a, 14b.

In the blade portion 3 of the tool body 2, at least a part providing each of the ball-nosed end cutting edges 12a, 12b is made of a hard sintered body that is constituted principally by polycrystalline cubic boron nitride (PCBN). In the present embodiment, the ball-nosed end cutting edges 12a, 12b cooperate with each other to define a diameter of about 2 mm. That is, a ball nose radius R of the ball endmill is 1 mm. It is noted that the above-described part providing each of the ball-nosed end cutting edges 12a, 12b may be made of a hard sintered body constituted principally by polycrystalline diamond (PCD) having a high degree of hardness.

The blade portion 3 of the tool body 2 is provided by a laminated body including two layers that are bonded to each other by sintering. One of the two layers is made of the hard sintered body, while the other layer is made of the cemented carbide. In a process of manufacturing the tool body 2, the blade portion 3 provided by the laminated body is fixed to an axial end of the other portion of the tool body 2 by brazing or soldering. After the blade portion 3 has been fixed to the other portion of the tool body 2, the above-described chip-evacuation flutes 10a, 10b, peripheral cutting edges 11a, 11b, ball-nosed end cutting edges 12a, 12b, lands 13a, 13b and spiral gashes 14a, 14b are formed in the blade portion 3, so that the blade portion 3 has a predetermined configuration.

Since the hard sintered body has a high degree of hardness, it is not so easy to machine the blade portion 3. Therefore, if the blade portion 3 were designed to have a large diameter, the manufacturing cost would be increased to a non-practicable level. In view of this, it is preferable that the diameter of the blade portion 3 is not larger than about 6 mm. In the present embodiment, the diameter of the blade portion 3 is about 2 mm

The chip-evacuation flutes 10a, 10b are provided for accommodating therein chips produced during the machining operation and then facilitating evacuation of the chips away from the machined surface of the workpiece. In the present embodiment, the chip-evacuation flutes 10a, 10b are provided by twisted flutes that are arranged to be symmetrical with respect to the axis L of the tool body 2.

The peripheral cutting edges 11a, 11b are formed in the blade portion 3, and are provided by respective two ridge lines at which the chip-evacuation flutes 10a, 10b interest with the lands 13a, 13b each having a predetermined width as measured in a circumferential direction of the blade portion 3. Each of the peripheral cutting edges 11a, 11b is inclined with respect to the axis L by a helix angle θ1 of about 30° in the present embodiment.

The ball-nosed end cutting edges 12a, 12b are formed in the blade portion 3, and describe a semi-spherical-shaped locus while the ball endmill 1 is being rotated. The ball-nosed end cutting edges 12a, 12b are arranged to be symmetrical with respect to the axis L of the tool body 2, and cooperate with each other to have a generally letter-S shape as seen in a distal end view perpendicular to the axis L (see FIG. 3). Each of the ball-nosed end cutting edges 12a, 12b is arranged to be contiguous to a corresponding one of the peripheral cutting edges 11a, 11b.

The spiral gashes 14a, 14b are provided by respective two recesses contiguous to the chip-evacuation flutes 10a, 10b, for facilitating evacuation of the chips away from the ball-nosed end cutting edges 12a, 12b. Each of the spiral gashes 14a, 14b has opposite side surfaces one of which provides a rake face of a corresponding one of the ball-nosed end cutting edges 12a, 12b. For example, a left-side one, as seen in FIG. 2, of the opposite side surfaces of the spiral gash 14a provides the rake face of the ball-nosed end cutting edge 12a. The ball-nosed end cutting edges 12a, 12b are provided by respective two ridge lines at which the spiral gashes 14a, 14b interest with the lands 13a, 13b.

A helix angle θ2, by which each of the spiral gashes 14a, 14b is inclined with respect to the axis L, namely, by which each of the ball-nosed end cutting edges 12a, 12b is inclined with respect to the axis L is preferably in a range from about 10° to about 30°. If the helix angle θ2 of each of the spiral gashes 14a, 14b is smaller than about 10°, the cutting performance of each of the ball-nosed end cutting edges 12a, 12b is reduced whereby the machining efficiency is reduced. On the other hand, if the helix angle θ2 is larger than about 30°, the cutting edge could easily suffer from chipping, resulting in reduction in the tool life of the ball endmill 1. In the present embodiment, the helix angle θ2 of each of the spiral gashes 14a, 14b is about 20°, so that it is possible to prevent reduction in the machining efficiency and also reduction in the tool life.

Further, a rake angle of each of the rake faces of the ball-nosed end cutting edges 12a, 12b defined by the spiral gashes 14a, 14b is preferably in a range from about −30° to about −10°. If the rake angle is larger, in a negative sense, than −30°, the cutting performance of the ball-nosed end cutting edges 12a, 12b is reduced whereby the machining efficiency is reduced. On the other hand, if the rake angle is larger, in a positive sense, than −10°, the ball-nosed end cutting edges 12a, 12b could easily suffer from chipping, resulting in reduction in the tool life of the ball endmill 1. In the present embodiment, the rake angle on each of the ball-nosed end cutting edges 12a, 12b is about −20°, so that it is possible to prevent reduction in the machining efficiency and also reduction in the tool life.

It is common that, in a ball endmill made of cemented carbide, the rake angle on each ball-nosed end cutting edge is in a range of positive value for improving the cutting sharpness or performance, and that the cutting edge is chamfered for preventing chipping of the cutting edge. On the other hand, in the ball endmill 1 of the present embodiment, cutting blades providing the ball-nosed end cutting edges 12a, 12b are constituted by the hard sintered body, and the rake angle on each of the ball-nosed end cutting edges 12a, 12b is in a range of negative value for obtaining strength of the cutting edge. This arrangement eliminates necessity of chamfering the cutting edge, thereby providing an advantage of simplifying a process of manufacturing the ball endmill 1.

Referring next to FIG. 4, there will be described a non-gashed central area in which the ball-nosed end cutting edges 12a, 12b or spiral gashes 14a, 14b are absent. FIG. 4 is an enlarged view showing in enlargement a portion defined by broken line A of FIG. 3.

As shown in FIG. 4, the non-gashed central area, whose center lies at the axis L, has a thickness or size t, which is preferably in a range from about 0.03 mm to about 0.1 mm. In the present embodiment in which the ball nose radius R is 1 mm, the size t of the non-gashed central area is not smaller than 0.03R and is not larger than 0.1R. In the non-gashed central area, a rotational speed is slow, and a large friction is generated. Therefore, if the size t of the non-gashed central area is smaller than about 0.03 mm, the tool body 2 is likely to be easily broken at the non-gashed central area due to reduction in rigidity of the tool body 2 at the non-gashed central area. On the other hand, if the size t of the non-gashed central area is larger than about 0.1 mm, the friction acting between the non-gashed central area and a machined surface of the workpiece is increased whereby a smoothness of the machined surface is reduced, so that the machining efficiency is reduced since the machining operation cannot be performed at a high speed. In the present embodiment, the size t of the non-gashed central area is about 0.3 mm. Owing to this arrangement, it is possible to prevent reduction in the machining efficiency and also reduction in the tool life.

Next, there will be described a cutting test that was conducted by using the ball endmill 1 constructed as described above. In the cutting test, the ball endmill 1 was moved, with a predetermined cutting condition, along linear reciprocation paths on a workpiece surface that is to be machined, and a width of wear on each of the ball-nosed end cutting edges 12a, 12b and also a roughness of the machined surface were measured.

Specification of the cutting condition in the cutting test is as follows:
Material of the workpiece: JIS-SKH51 (65HRC)
Cutting method: Down-cut milling
Supplied cutting fluid: Mist coolant
Used machine: Vertical type machining center
Cutting speed: 251.2 m/min
Feed rate per tooth: 0.075 mm/t
Axial depth aa of cut: 0.05 mm
Pick feed amount Pf 0.02 mm

The cutting test was conducted by using, in addition to the ball endmill 1 (hereinafter referred to as “invention product A”) in which at least the part providing each of the ball-nosed end cutting edges 12a, 12b was made of the hard sintered body, a ball endmill (herein after referred to as “conventional product”) which was made of a cemented carbide. It is noted that the invention produce A and the conventional product B were identical in configuration with each other.

FIG. 5 is a view showing a result of the cutting test conducted by using the invention product A and the conventional product B, and indicates a relationship between a cut distance X1 and a wear width Y1 with respect to each of the invention and conventional products A, B. In FIG. 5, an abscissa 23 represents the cut distance X1 by which the workpiece was machined in the cutting test, while an ordinate 24 represents the wear width Y1 on each ball-nosed end cutting edge. A polygonal line 25 is a (solid) line joining data points (each denoted by black triangle ▴) relating to the invention product A, while a polygonal line 26 is a (solid) line joining data points (each denoted by black square ♦) relating to the conventional product B.

In comparison between the polygonal lines 25, 26 in FIG. 5, it is appreciated that the wear width Y1 on the invention product A and the wear width Y1 on the conventional product B are both increased as the cut distance X1 is increased, and that a rate of the increase is indicated by an inclination represented by a line which is substantially straight after the cut distant X1 exceeds about 100 m. However, the inclination indicating the rate of the increase in the wear width Y1 on the conventional product B is larger than the inclination indicating the rate of the increase in the wear width Y1 on the invention product A. That is, in the invention product A, it was possible to reduce the rate of increase in the wear width Y1 in relation with the cut distance X1, as compared with in the conventional product B.

FIG. 6 is a view showing a result of the cutting test conducted by using the invention product A and the conventional product B, and indicates a relationship between a cut distance X2 and a surface roughness Y2 of the machined surface.

In FIG. 6, an abscissa 27 represents the cut distance X2 by which the workpiece was machined in the cutting test, while an ordinate 28 represents the surface roughness Y2 of the machined surface of the workpiece. A polygonal line 29 is a (solid) line joining data points (each denoted by black triangle ▴) relating to the invention product A, while a polygonal line 30 is a (solid) line joining data points (each denoted by black square ♦) relating to the conventional product B. It is noted that the surface roughness Y2 of the machined surface is a maximum height Rz that is measured in accordance with JIS B0601-2001.

In comparison between the polygonal lines 29, 30 in FIG. 6, it is appreciated that, after the cut distant X2 exceeds about 134 m, the surface roughness Y2 in the invention product A and the surface roughness Y2 in the conventional product B are both increased as the cut distance X2 is increased. However, after the cut distance X2 exceeds about 288 m, an amount of increase in the surface roughness Y2 in the conventional product B is extremely larger than that in the invention product A. That is, after the cut distance Y2 becomes large, the amount of increase in the surface roughness Y2 in relation with the amount of increase in the cut distance X2 is much smaller where the invention product A is used, than where the conventional product B is used.

Further, in a stage between the cut distance X2 of about 10 m and about 134 m, the change in the surface roughness Y2 in the conventional product B is more irregular than that in the invention product A. Further, in any stage, the surface roughness Y2 in the invention product A is smaller than that in the conventional product B. That is, the invention product A was capable of providing a surface smoothness that is more stable than that provided by the conventional product B.

As is clear from the above description, the ball endmill 1 (invention product A) of the invention, in which at least the part providing each of the ball-nosed end cutting edges 12a, 12b is made of the hard sintered body, exhibits more excellent wear resistance and also provides more excellent and stable surface smoothness, as compared with the ball endmill (conventional product B) having the same configuration and made of the cemented carbide. Therefore, the ball endmill 1 is capable of perform a machining operation at a high cutting speed with a large depth of cut.

While the present invention has been described based on the embodiment, it is to be easily imagined that the present invention is not at all limited to the details of the above-described embodiment but may be subjected to various improvements and modifications within a range that is not deviated from the gist of the invention.

For example, while the number of the ball-nosed end cutting edges 12a, 12b is two in the above-described embodiment, the present invention is equally applicable to a ball endmill having three or more ball-nosed end cutting edges.

1. (canceled)

2. (canceled)

3. (canceled)

4. A ball endmill comprising (a) a cylindrical tool body which is to be rotated about an axis thereof, (b) ball-nosed end cutting edges which are located in an axially distal end portion of said tool body and which describe a semi-spherical-shaped locus during rotation of said tool body, and (c) spiral gashes which are located in said axially distal end portion of said tool body and which define rake faces of the respective ball-nosed end cutting edges,
wherein said tool body is made, at least at a part thereof providing each of said ball-nosed end cutting edges, of a hard sintered body,
wherein each of said ball-nosed end cutting edges is inclined with respect to said axis by a helix angle that is in a range from about 10° to about 30°,
wherein said tool body has, in a distal end thereof, a non-gashed central area in which said spiral gashes do not exist,
and wherein a ratio of a size of said non-gashed central area to a ball nose radius is in a range from about 0.03 to about 0.1.

5. The ball endmill according to claim 4, wherein a radial rake angle on each of the ball-nosed end cutting edges is a negative rake angle in a range from about −30° to about −10°.

6. The ball endmill according to claim 4, wherein said hard sintered body is constituted principally by cubic boron nitride.

7. The ball endmill according to claim 4, wherein said hard sintered body is constituted principally by polycrystalline diamond.

8. The ball endmill according to claim 4, further comprising (d) peripheral cutting edges each of which is contiguous to a corresponding one of said ball-nosed end cutting edges and extends away from said axially distal end portion toward a shank portion of said tool body.

9. The ball endmill according to claim 4, wherein each of said ball-nosed end cutting edges is defined by a circular arc, as seen in a distal end view perpendicular to said axis of said tool body, which is convex in a direction of rotation of said tool body.
